(19) United States
(12) Patent Application Publication
(10) Pub. No.: US 2006/0141831 A1
(43) Pub. Date: Jun. 29, 2006

(54) Electrical connector

(75) Inventor: Chun-Hsiung Hsu, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/317,458

(22) Filed: Dec. 22, 2005

(30) Foreign Application Priority Data
Dec. 25, 2004 (CN) 200420054713.8

(51) Int. Cl. H01R 13/648

(52) U.S. Cl. 439/108

(57) ABSTRACT

A right-angled backplane connector (100) includes an insulative housing (20), a number of contacts (40) received in the housing (20), and a spacer (60) assembled to the housing. The housing (20) forms a front mating portion (22) adapted to mating with a mating connector and a rear mounting portion (24) integrally connected to the mating portion (22). The mounting portion (24) defines a bottom wall (244) adapted to be mounted on a printed circuit board. A number of mounting posts (248) protrudes from the bottom wall (244) to engage in a corresponding number of mounting holes defined in the printed circuit board. The mounting portion (24) further defines inserting slots (240) for a part of a fixture to be inserted therein to support the contacts when the contacts (40) are inserted into the housing (20) by the fixture.

### BACKGROUND OF THE INVENTION

1. Field of the Invention

The present invention relates to a backplane connector, and more particularly, to a right-angled backplane connector to be mounting on a printed circuit board.

2. Description of the Prior Art

A conventional right-angled backplane connector, disclosed in U.S. Pat. No. 4,583,807 issued to Kaufman et al. on Oct. 10, 1995, includes an insulative housing and a plurality of conductive contacts arranged in rows in the housing. The housing includes a U-shaped mating portion for engaging a mating connector and a mounting portion for being mounted on a printed circuit board. The mating portion forms a rear wall and a pair of lateral walls perpendicularly extending from two opposite end of the rear wall to define a slot for receiving the mating connector. The mounting portion extends backwardly from the rear wall for being mounted on the printed circuit board. A pair of metal posts are insert-molded into the mounting portion of the housing and laterally protrude for firmly positioning the connector to the printed circuit board. The contacts forms a contact portion in the slot and a securing portion engaging the mounting portion and a tail for making electrical connection to the printed circuit board. The securing portion of each contact has a great length mating with the mounting portion, which increases the difficulty to assemble the contacts to the housing. Further more, the tails of the contacts are disposed out side of the housing without any constraint and so tend to offset the right position, which will negatively affect the electrical connection between the tail and the substrate. Another similar conventional backplane connector, disclosed in U.S. Pat. No. 5,104,243 issued to Harding on Apr. 14, 1992, has the same defects as described above.

Still another conventional backplane connector is disclosed in either U.S. Pat. No. 5,593,307 issued to Bale et al. on Jan. 14, 2002 or U.S. Pat. No. 5,934,939 issued to Thenaisie et al. on Aug. 10, 1999. The backplane connector is similar to the ones described above except that the mounting portion is separative from the mating portion. The engagement between the mating portion and the mounting portion makes the mating portion is comparatively looser from the mounting portion, so that the mating force acting on the contacts is delivered directly to the connection between the tails of the contacts and the printed circuit board when the mating connector is inserted into the slot of the mating portion, which negatively affects the electrical connection thereof.

Hence, an improved right-angled backplane connector is needed to solve the above problems.

### BRIEF SUMMARY OF THE INVENTION

The present invention provides a right-angled backplane connector including an insulative housing and a plurality of conductive contacts received in the housing. The housing includes a front mating portion and a rear mounting portion adapted to be installed on a printed circuit board. The mounting portion extends backwardly from the mating portion. Each of the conductive contacts includes a securing portion engaging the mating portion, a contact portion forwardly from the securing portion, a supporting portion extending backwardly from the securing portion through the mounting portion, and a tail connected to the supporting portion in a right angle adapted to electrically connect the printed circuit board. The mounting portion defines a plurality of inserting slots parallel to the extending direction of the supporting portion.

In a preferred embodiment, the connector further includes a spacer connected to the mounting portion of the housing. The spacer forms a number of separating walls to define another number of slots for positioning the tails of the contacts. Each of the separating walls defines a slot facing the printed circuit board, while corresponding contacts forms a pair of blocks extending sideward from an up end of the tail. The blocks engage in the slots, which keeps the tails in position and help to the tails to form steady electrical connections with the printed circuit board.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded view of a backplane connector of the present invention, with only one set of contacts shown for clear showing;

FIG. 2 is a perspective view of a spacer of the backplane connector shown in FIG. 1;

FIG. 3 is a perspective assembled view of the backplane connector shown in FIG. 1;

FIG. 4 is another perspective view of the backplane connector of FIG. 3;

FIG. 5 is a sectional view of the modular jack taken along line 5-5 in FIG. 3; and

### DETAILED DESCRIPTION OF THE INVENTION

Reference will now be made to the drawing figures to describe the present invention in detail.

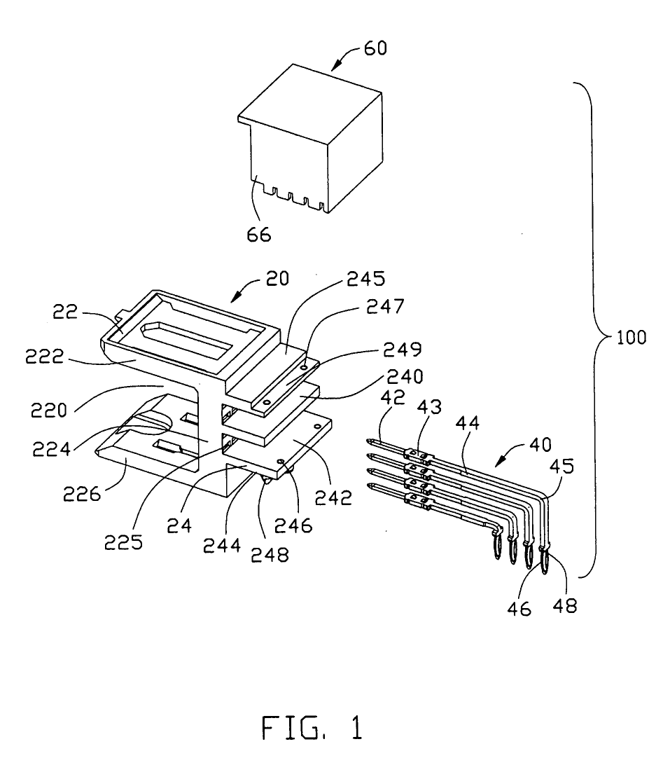

FIG. 1 shows a right-angled backplane connector 100 according to present invention. The connector 100 includes an insulative housing 20, a plurality of conductive contacts 40 received in the housing 20, and a spacer 60 assembled to the housing 20.

The housing 20 forms a mating portion 22 for engaging with a mating connector (not shown) and a mounting portion 24 integrally connected to the mating portion 22. The mating portion 22 forms a rear wall extending uprightly and a pair of lateral walls 222,226 extending forwardly from opposite ends of the rear wall 224 to define a U-shaped slot 220 facing forwardly. The rear wall 224 defines rows of contact holes 225 cutting through the rear wall 224 perpendicularly. The mounting portion 24 extends backwardly from the rear wall 224 and forms a plurality of partition walls (not labelled). Said partition walls define a pair of inserting slots 240 parallel to the lateral walls 222,226. The inserting slots 240 cut through the housing 20 horizontally and communicate two rows of contact holes 225. The partition walls include a bottom wall 244 and a top wall 245 parallel to the lateral sidewalls 222,226. The bottom wall 244 is adapted to be mounted on a printed circuit board and three mounting posts 248 protrude there from. The mounting posts are used to engage in three through holes defined in the printed circuit board for firmly securing the connector 100 to the printed circuit board. Backward along the bottom wall 244, the mounting portion 24 extends a fastening board 242 in which two fastening holes 246 are defined. The top wall 244 forms a step 249 at the end and the step 249 defines a pair of fastening holes 247 therein communicating the inserting slot 240.

Each of the contacts 40 includes a securing portion 43 for engaging in corresponding contact hole 225, a contact portion 42 extending forwardly from the securing portion 43 for contacting corresponding contact arranged in the mating connector, a supporting portion 44 extending backwardly from the securing portion 43, a tail 46 perpendicular to the supporting portion 44 for electrically connecting the printed circuit board, and an elbow portion 45 bent in a right angle connecting the tail 46 to the supporting portion 44. Furthermore, the contact 44 opposite sideward protrudes a pair of block 48 at a top end of the tail 46.

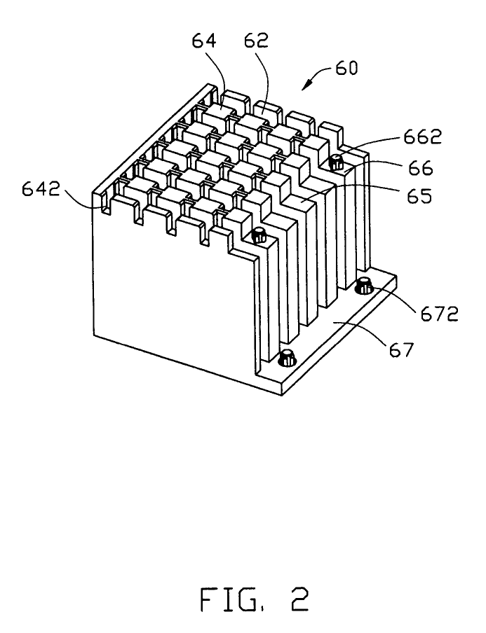

Referring to FIG. 2, the spacer 60 forms a number of separating walls 64 to define a corresponding number of receiving slots 62 to accommodate the elbow portion 45 of the contacts 40. The separating walls 64 extend to abut the printed circuit board and define a plurality of pressing slots 642 open to the printed circuit board. Corresponding to the step 249 of the housing 20, the spacer 66 protrudes a fastening tab 67 and the fastening tab 67 protrudes a pair of fastening posts 672 corresponding to the fastening holes 247. The spacer 60 further forms a step 65 to abut the fastening board 242 so that a plurality of shoulders 66 is formed. Two of the shoulders 66 protrude a pair of fastening posts 662 corresponding to the fastening holes 246.

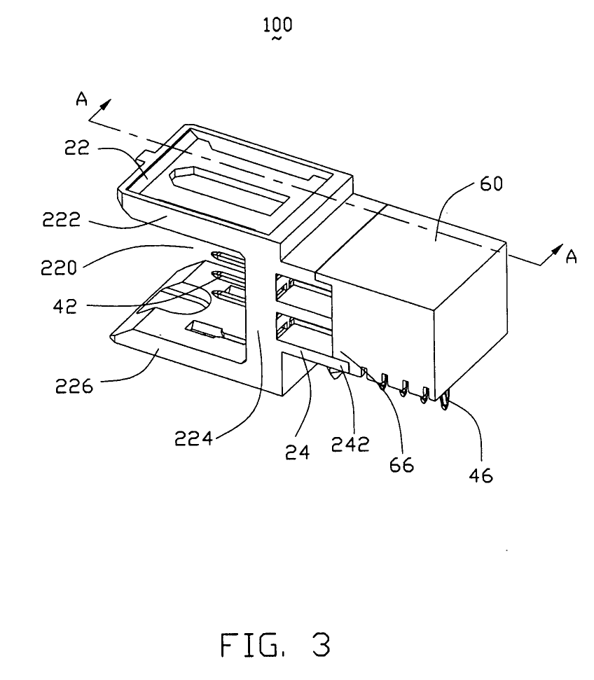

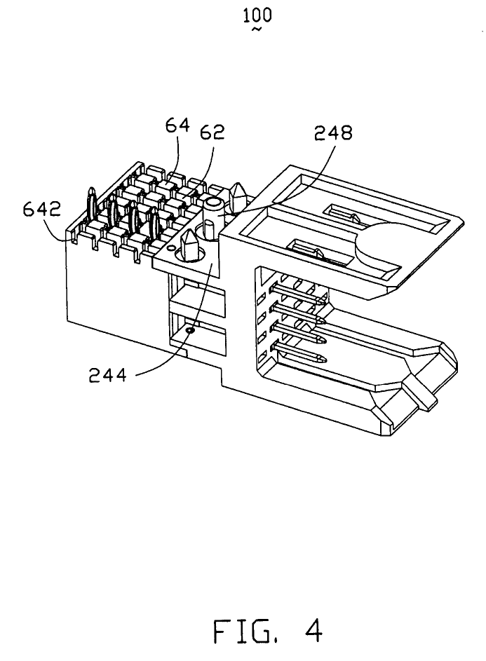

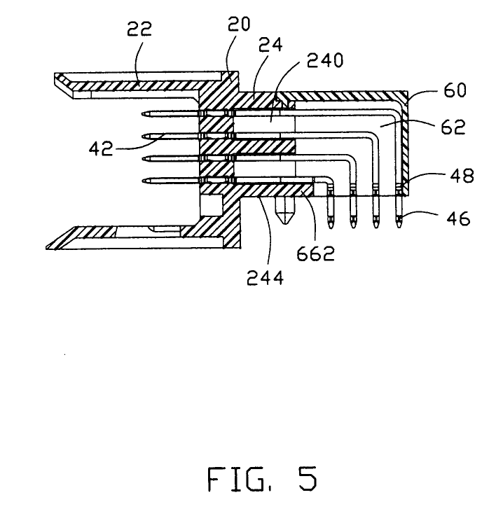

Referring to FIGS. 3, 4, 5, to assemble the connector 100, the housing 20, a plurality of contacts 40 and the spacer 60 is respectively provided. Firstly, the contacts 40 are inserted partly into the contact holes 225 to a first position where the contacts 40 are loosely positioned. Secondly, the contacts 40 are pressed into the housing 20 to a final position where the securing portions 43 of the contacts 40 are firmly secured by the rear wall 224 of the housing 20. When the contacts 40 are being pressed to the final position by a tool, a part of the tool is inserted into the inserting slots 240 to support the supporting portion 44 in case that the supporting portion 44 become crooked. Finally, the spacer 60 is assembled to the housing 20 with the fastening posts 662,672 fitting into the fastening holes 246,247. Then, the elbow portions 45 of the contacts 44 are received in corresponding receiving slots 62 and the blocks 48 are received in the pressing slots 640 to position the tails 46 of the contacts 40 for facilitating later insertion of the tails 46 into the holes defined in the printed circuit board.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

I claim:

1. An electrical connector mounted on a printed circuit board (PCB) comprising:
an insulative housing having a front mating portion and a rear mounting portion extending backwardly from the front mating portion; and
a plurality of conductive contacts arrayed in the housing;
wherein said rear mounting portion forms a plurality of partition walls extending parallel to the printed circuit board and defining therebetween a plurality of inserting slots providing enough space for receiving a part of a tool when said contacts are being inserted into the housing by the tool.

2. The electrical connector according to claim 1, wherein each of said contacts comprises a securing portion retained within the mating portion, a mating portion extending forwardly from the securing portion, a supporting portion extending backwardly from the securing portion, and a tail portion perpendicularly projecting from said supporting portion and electrically connecting said printed circuit board.

3. The electrical connector according to claim 1, wherein said partition walls include a bottom wall mounted on the printed circuit board, said bottom wall having a plurality of mounting posts downwardly protruding therefrom.

4. The electrical connector according to claim 1, wherein said mating portion forms a rear vertical wall and a pair of lateral horizontal walls to define a space therebetween.

5. The electrical connector according to claim 1, further comprising a spacer fastened to said rear mounting portion of the housing, wherein said spacer forms a plurality of separating walls to define a plurality of receiving slots for receiving said contacts.

6. The electrical connector according to claim 5, wherein each of said contacts comprises a securing portion retained within the mating portion, a mating portion extending forwardly from the securing portion, a supporting portion extending backwardly from the securing portion, and a tail portion perpendicularly projecting from said supporting portion and electrically connecting said printed circuit board.

7. The electrical connector according to claim 6, wherein said separating walls define a plurality of pressing slots facing the printed circuit board, each of said contacts forming a pair of blocks at a top end of said tail of the contact, said pair of blocks engaging in corresponding pressing slots.

8. The electrical connector according to claim 5, wherein said spacer forms a plurality of fastening posts and said mounting portion of the housing defines a corresponding number of fastening holes, said fastening posts engaging in said fastening holes to fasten said spacer to said housing.

9. An electrical connector comprising:
an insulative housing defining a front mating portion and a rear mounting portion;
a plurality of terminals disposed in the housing with a mating section disposed in the mating portion and right angle type mounting section disposed in the mounting portion;
each of the mounting section including a pair of laterally extending blocks engagably received in a pair of corresponding slots formed in a bottom edge of the mounting portion.

10. The electrical connector as claimed in claim 9, wherein said terminals are arranged in columns and rows, and each of said columns includes more than one terminals so as to form more than one pair of slots along each of said columns for engagably receiving more than one pair of blocks.

11. The electrical connector as claimed in claim 10, wherein said more than one pair of slots are arranged in a same horizontal plane along said column.

12. The electrical connector as claimed in claim 10, wherein more than one dividers are formed on a rear portion of the mating portion to separate the mounting portions of the corresponding terminals located in the different rows.

13. The electrical connector as claimed in claim 12, wherein the mounting portion defines an engagement device to engage each of said dividers.

14. An electrical connector comprising:
an insulative housing defining a front mating portion and a rear mounting portion;
a plurality of terminals disposed in the housing with a mating section disposed in the mating portion and right angle type mounting section disposed in the mounting portion, said terminals are arranged in columns and rows, and each of said columns includes more than one terminals;
more than one dividers being formed on a rear portion of the mating portion to separate the mounting portions of the corresponding terminals located in the different rows; wherein
the mounting portion defines an engagement device to engage each of said dividers.
